(19) United States
(12) Patent Application Publication
(10) Pub. No.: US 2019/0159473 A1
(43) Pub. Date: May 30, 2019

(54) Solid beverage for conditioning dampness-heat constitution and processing method thereof

(71) Applicant: Zhonghua CI, Beijing (CN)

(72) Inventor: Zhonghua CI, Beijing (CN)

(21) Appl. No.: 15/874,305

(22) Filed: Jan. 18, 2018

(30) Foreign Application Priority Data
Nov. 30, 2017 (CN) 2017112425307

(51) Int. Cl. A23F 3/00; A23L 2/39

(52) U.S. Cl. CPC A23F 3/00; A23V 2250/214; A23V 2002/00; A23L 2/39

(57) ABSTRACT

The invention discloses a solid beverage for conditioning dampness-heat constitution. The solid beverage comprises in parts by weight the following ingredients of raw materials: from 18 to 40 parts of agastache rugosa, from 22 to 41 parts of dandelion, from 15 to 45 parts of honeysuckle, from 16 to 42 parts of rhizoma phragmitis, from 17 to 45 parts of lophatherum gracile, from 18 to 38 parts of fried semen raphani, from 20 to 43 parts of semen coicis, from 21 to 45 parts of houttuynia, from 23 to 43 parts of dextrin, from 15 to 38 parts of maltodextrin, from 30 to 60 parts of soluble starch, and from 0.1 to 0.3 parts of aspartame. The solid beverage of the invention has the advantages of simple and convenient manufacture. All the raw materials used are both medicinal and edible materials, and the excipients used are all in conformity with the national standard GB2760-2011 (National Food Safety Standard for Food Additive Use). It is safe to consume with good taste, and has a certain effect of improving the dampness-heat constitution. Moreover, the processing process is suitable for large-scale industrial production.

### TECHNICAL FIELD

The present invention relates to the field of health food, in particular to a solid beverage for conditioning dampness-heat constitution and a processing method thereof.

### BACKGROUND

According to “Standard of Classification and Determination of Constitution in TCM” issued by China Association of Traditional Chinese Medicine, the constitution of human bodies is classified by nine types, namely, balanced constitution, yang-deficiency constitution, yin-deficiency constitution, qi (vital energy)-deficiency constitution, phlegm-dampness constitution, dampness-heat constitution, qi-stagnation constitution, blood-stasis constitution, and allergic (special, tebing) constitution. Most of them belong to sub-health status.

The so-called dampness, which is commonly referred to as water-dampness, includes exogenous and endogenous dampness. The exogenous dampness is caused by invasion of exogenous water-dampness into the human body as a result of humid climate, wading, exposure to the rain or dampness of living room. The endogenous dampness is a pathological product and often relates to digestive function. It is believed by traditional Chinese medicine that the spleen has the function of “transportation and transformation of water-dampness”. In case of indigestion due to weakness, overeating or eating too much oily food or sweets, the spleen can not perform the function of transportation and transformation of water-dampness, leading to “water-dampness retention”. Moreover, people with spleen deficiency tend to incur invasion of exogenous water-dampness, and the functioning of spleen and stomach is often frustrated by exogenous dampness, leading to endogeny of dampness. Thus there is an independent and related relationship between the exogenous dampness and the functioning of spleen and stomach. The so-called heat is a kind of symptom cause by heat. In the case of dampness-heat, the heat and dampness coexist. Because dampness and heat invades simultaneously the human body due to the muggy weather in summer and autumn, or the dampness is retained for a long time to transform into heat, or the dampness is transformed by the “yang-heat constitution” “from yang into heat”, the simultaneous presence of dampness and heat is very common.

The dampness-heat constitution, one of sub-health constitutions, is a chronic condition which has a long course of disease, thus a long-term medication and gradual conditioning are required to achieve the effect of dampness-heat removal. The dosage form commonly used in traditional Chinese medicine includes decoction and proprietary Chinese medicine such as pills. The decoction has better efficacy, but has relatively cumbersome administration and poor taste. In the case of long-term medication, it is not easy for the patients to persist in the medication. Moreover, the efficacy of pills is relatively poor.

Food is the best product for disease prevention and health care of human beings, and the viewpoint of “medicine and food homology” is one of the most valuable contributions to human beings in Chinese original medicine. “Curing diseases by combining five tastes, five cereals, and five medicines, described in “Rites of Zhou⋅Tianguan⋅Curing sickness”, indicates the physiological health-care function of food. A method of regulating organism using properties of food to get healthy or cure diseases is called as food therapy (nutrition therapy, dietary therapy). However, “nutrition supplement” is better than “therapy”. Dietary nourishment refers to nutrition supplement using nutritional effects of food according to the individual's physical condition to enhance resistibility and immunity, and further to extend life-span and have a robust physique. It is described in “Qian Jin Prescriptions” that a doctor should firstly know the source of a disease and symptoms, then treat the disease with corresponding food. If the disease cannot be cured through food therapy, then a medicine is used. It can be seen that the application of food therapy is not only the basic treatment means of doctors at that time, but also an important ground for evaluating whether a doctor has excellent medical skills.

It is proposed in “Huangdi Neijing (The Yellow Emperor's Classic of Medicine)” that “making preventive treatment before getting illness is the top-class medical skill, performing treatment when illness is suspected is the middle-class medical skill, and performing treatment when illness is present is the low-class medical skill”. “Making preventive treatment before getting illness” refers to prevention of occurrence and development of illness by taking appropriate measures. The constitution determines our health and susceptibility to diseases. In the face of various diseases, earlier age at onset, and increasing population in sub-health condition, the food therapy is favored by more and more consumers due to its advantages of being healthy and natural. With regard to frequently encountered problems, it is of critical significance to develop a food product with good taste having the function of health care and conditioning dampness-heat constitution by combining the precious experience of traditional Chinese health care and rich knowledge accumulation in conditioning dampness-heat constitution by the traditional Chinese medicine, using modern scientific and technological methods, based on the medicine and food homology.

### DISCLOSURE OF THE INVENTION

A main object of the present invention is to provide a health-care food for conditioning dampness-heat constitution.

In order to achieve the above object, according to one aspect of the present invention, a solid beverage for conditioning dampness-heat constitution is provided.

The solid beverage for conditioning dampness-heat constitution according to the present invention comprises in parts by weight the following ingredients of raw materials: from 18 to 40 parts of agastache rugosa, from 22 to 41 parts of dandelion, from 15 to 45 parts of honeysuckle, from 16 to 42 parts of rhizoma phragmitis, from 17 to 45 parts of lophatherum gracile, from 18 to 38 parts of fried semen raphani, from 20 to 43 parts of semen coicis, from 21 to 45 parts of houttuynia, from 23 to 43 parts of dextrin, from 15 to 38 parts of maltodextrin, from 30 to 60 parts of soluble starch, and from 0.1 to 0.3 parts of aspartame.

Further, the solid beverage for conditioning dampness-heat constitution according to the present invention comprises in parts by weight the following ingredients of raw materials: from 23 to 37 parts of agastache rugosa, from 26 to 35 parts of dandelion, from 22 to 38 parts of honeysuckle, from 21 to 37 parts of rhizoma phragmitis, from 20 to 39 parts of lophatherum gracile, from 22 to 33 parts of fried semen raphani, from 25 to 35 parts of semen coicis, from 24 to 39 parts of houttuynia, from 27 to 37 parts of dextrin, from 18 to 33 parts of maltodextrin, from 35 to 55 parts of soluble starch, and from 0.15 to 0.25 parts of aspartame.

Further, the solid beverage for conditioning dampness-heat constitution according to the present invention comprises in parts by weight the following ingredients of raw materials: 30 parts of agastache rugosa, 30 parts of dandelion, 30 parts of honeysuckle, 30 parts of rhizoma phragmitis, 30 parts of lophatherum gracile, 30 parts of fried semen raphani, 30 parts of semen coicis, 30 parts of houttuynia, 30 parts of dextrin, 25 parts of maltodextrin, 45 parts of soluble starch, and 0.2 parts of aspartame.

In order to achieve the above object, according to another aspect of the present invention, a method for processing a solid beverage for conditioning dampness-heat constitution is provided.

The method for processing a solid beverage for conditioning dampness-heat constitution according to the present invention comprises the steps of:

(1) Preparation of raw materials: subjecting agastache rugosa, semen coicis, dandelion, honeysuckle, houttuynia, rhizoma phragmitis, lophatherum gracile and fried semen raphani to decontamination, purification, cutting and pulverization followed by mixing them for subsequent use;

(2) decoction: decocting twice the mixture obtained in step (1) with addition of water to obtain a Chinese medicine liquid;

(3) concentration: feeding the Chinese medicine liquid obtained in step (2) into a thickener via a pipeline, and concentrating it into a thick paste;

(4) wet granulation: mixing dextrin, maltodextrin, soluble starch and aspartame under stirring to obtain a mixed excipient, and adding the thick paste obtained in step (3) to the mixed excipient, followed by stirring granulation.

Further, the twice decocting processes in the step (2) are operated as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

Further, the temperature for the concentration in the step (3) is 70-80° C., and the relative density of the resulted thick paste is 1.2-1.5 at a temperature of 50° C.

Further, the wet granulation in the step (4) comprises the steps of:

(4.1) dry blending: feeding dextrin, maltodextrin, soluble starch, and aspartame into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time;

(4.3) drying: putting the sized particles obtained in step (4.2) into a boiling dryer for drying;

(4.4) secondary sizing: performing the second time of sizing by an oscillating machine;

Further, the sieve used for the primary sizing is a 12-mesh sieve, and the sieve used for the secondary sizing is a 10-mesh sieve.

Further, the material temperature during the drying process in step (4.3) is controlled at 70-80° C. and the final moisture content of the material is controlled below 5%.

Further, after the secondary sizing, the method further comprises a particle-selecting step wherein particles of 10 to 60 mesh are selected.

The solid beverage of the invention has the advantages of simple and convenient manufacture. All the raw materials used are both medicinal and edible materials, and the excipients used are all in conformity with the national standard GB2760-2011 (National Food Safety Standard for Food Additive Use). It is safe to consume with good taste, and has a certain effect of improving the dampness-heat constitution. Moreover, the processing process is suitable for large-scale industrial production.

### BRIEF DESCRIPTION OF DRAWINGS

The drawings constituting a part of the invention are provided for further understanding of the present invention, so as to make other features, objectives and advantages of the invention more apparent. The drawings for exemplary embodiments of the invention and description thereof are intended to explain the invention, rather than improperly limiting the invention. In the drawings:

FIG. 1 shows a processing process of a solid beverage according to an embodiment of the invention;

FIG. 2 shows specific steps of wet granulation in a processing process of a solid beverage according to an embodiment of the invention.

### DETAILED DESCRIPTION OF EMBODIMENTS

The technical solutions of the embodiments of the invention are clearly and completely described below with reference to the accompanying drawings for the embodiments of the invention, for a better understanding of the solutions of the invention by a person skilled in the art. Apparently, the described embodiments are merely a part but not all of embodiments of the invention. All other embodiments obtained by persons of ordinary skill in the art based on the embodiments of the invention without inventive efforts shall fall in the protective scope of the invention.

Furthermore, the terms “comprise” and “have” and any variants thereof are intended to encompass a non-exclusive inclusion. For example, a process, method, system, product or apparatus that encompasses a series of steps or units is not necessarily limited to those steps or units specifically listed, but may include other steps or units not specifically listed or inherent to such process, method, product or apparatus.

It should be noted that the embodiments of the invention and the features in the embodiments can be combined with each other without conflict. The invention will be described in detail below with reference to the accompanying drawings and embodiments.

A main object of the present invention is to provide a health-care food for conditioning dampness-heat constitution.

In order to achieve the above object, according to one aspect of the present invention, a solid beverage for conditioning dampness-heat constitution is provided.

The solid beverage for conditioning dampness-heat constitution according to the present invention comprises in parts by weight the following ingredients of raw materials: from 18 to 40 parts of agastache rugosa, from 22 to 41 parts of dandelion, from 15 to 45 parts of honeysuckle, from 16 to 42 parts of rhizoma phragmitis, from 17 to 45 parts of lophatherum gracile, from 18 to 38 parts of fried semen raphani, from 20 to 43 parts of semen coicis, from 21 to 45 parts of houttuynia, from 23 to 43 parts of dextrin, from 15 to 38 parts of maltodextrin, from 30 to 60 parts of soluble starch, and from 0.1 to 0.3 parts of aspartame.

Agastache rugosa: The agastache rugosa, used as whole plant medicine, is spicy in taste and mild in nature and exerts the curative effect through spleen, stomach and lung. The agastache rugosa has functions of dissipating dampness, removing waste from body and regulating middle-qi, relieving heat stroke, dispersing the pharmaceutical effect to external. Indications include impaired function of spleen and stomach by dampness, abdominal distension, occurrence of dampness, vomiting, diarrhea, summer-heat and damp, fever with chilliness, chillness with fever and oppression in chest, etc.

Dandelion: The dandelion is sweet and bitter in taste and cold in nature, and exerts the curative effect through liver and stomach. The dandelion has functions of clearing heat and removing toxicity, promoting urination and eliminating stagnation. Indications include acute mastitis, lymphadenitis, scrofulosis, furunculosis, acute conjunctivitis, rethum and pyrexia, acute tonsillitis, acute bronchitis, gastritis, hepatitis, cholecystitis, urinary tract infections.

Honeysuckle: The honeysuckle is sweet in taste and cold in nature, and exerts the curative effect through lung and stomach. The honeysuckle has functions of clearing heat and removing toxicity, and diminishing inflammation for detumescence. Indications include exogenous wind-heat or fever due to warmness, heat stroke, heat toxemia, carbuncle boils and scabies, laryngeal paralysis, and a variety of infectious diseases.

Rhizoma phragmitis: The rhizoma phragmitis is sweet in taste and cold in nature, and exerts the curative effect through lung and stomach. The rhizoma phragmitis has functions of clearing heat-fire, helping produce saliva and slaking thirst, relieving restlessness, arresting vomiting, and promoting urination. Indications include fever polydipsia, lung heat dry cough, internal heat diabetes, and swelling and ulcer.

Lophatherum gracile: The lophatherum gracile is sweet and light in taste and cold in nature, and exerts the curative effect through heart, lung, stomach and bladder. The lophatherum gracile has functions of clearing heat-fire, relieving restlessness and promoting urination. Indications include fever polydipsia, aphtha and red urine, heat strangury and astringent pain.

Fried semen raphani: The fried semen raphani is mild in nature and spicy and sweet in taste, and exerts the curative effect through lung, spleen and stomach. The fried semen raphani has functions of promoting digestion and relieving flatulence, and depressing qi and reducing phlegm. Indications include food stagnation, abdominal distension and pain, constipation, stagnation and diarrhea, sputum, asthma and cough.

Semen coicis: The semen coicis is sweet and light in taste and cool in nature, and exerts the curative effect through spleen, stomach and lung. The semen coicis has functions of promoting urination and excreting dampness, tonifying spleen and checking diarrhea, relieving paralysis, apocenosis, removing toxicity and eliminating stagnation. Indications include edema, beriberi, difficult urination, diarrhea due to spleen deficiency, arthralgia due to dampness and muscular contracture, pulmonary abscess, periappendicular abscess; warts, and carcinoma.

Houttuynia: The houttuynia is spicy in taste and slightly cold in nature, and exerts the curative effect through lung. The houttuynia has functions of clearing heat and removing toxicity, dissolving carbuncle and drainage of pus, and promoting urination and treating stranguria. Indications include pulmonary abscess and pyemesis, dyspnea with cough due to phlegm-heat, dysentery due to heat, heat strangury, carbuncle and sore-toxin.

The general manifestations of dampness-heat are as follows: heavy limbs, obvious fever in the afternoon which can not be relieved by sweating; greasy tongue coating and rapid pulse. Depending on the different parts of body where dampness-heat is present, the specific manifestations varies, for example, are eczema or malignant boil in the case of in skin and flesh; local swelling and pain in the case of the joints, tendon and vessel. But the commonly said dampness-heat often refers to dampness-heat into internal organs, especially dampness-heat in the spleen and stomach, which is manifested as epigastric oppression and fullness of the abdomen, nausea and anorexia, loose stool, short and red urine, soft pulse. The other dampness-heat includes, such as, dampness-heat in liver and gallbladder which is manifested as liver swelling pain, mouth with bitter taste and poor appetite, skin and eyes yellowing, alternate fever and cold, wiry pulse; dampness-heat in bladder which is manifested as frequent urination, urgent urination, astringent urination and urination pain, yellow and turbid urine; dampness-heat in intestinum which is manifested as abdominal pain and diarrhea and even tenesmus, bloody purulent stool, burning pain in anus, and thirsty. Since the symptoms of the dampness-heat have a variety of manifestation, therapy should be divided into eliminating dampness and clearing heat-fire. In the prescription, the agastache rugosa has functions of dissolving turbidity with fragrance, arresting vomiting by regulating the middle-qi, dispersing the pharmaceutical effect to external and relieving summer-heat; semen coicis has functions of eliminating arthralgia due to dampness, regulating intestines and stomach, moisturizing skin; the dandelion has functions of clearing heat and removing toxicity, promoting urination and eliminating stagnation, and tonifying spleen and stomach; the honeysuckle has functions of clearing summer-heat, anti-inflammation, and tonifying deficiency; the houttuynia has functions of clearing heat and removing toxicity, dissolving carbuncle and drainage of pus, and promoting urination and treating stranguria; the rhizoma phragmitis has functions of clearing heat-fire, helping produce saliva, relieving restlessness, arresting vomiting, and promoting urination; the lophatherum gracile heat has functions of clearing heat-fire, relieving restlessness and promoting urination; and the fried semen raphani has functions of promoting digestion and relieving flatulence, and depressing qi and reducing phlegm.

Conditioning of dampness-heat constitution employs “clearing heat and promoting urination for conditioning” as a principle. A condition of heat more than dampness is common in people with dampness-heat constitution. In the prescription, the dandelion and honeysuckle are capable of clearing heat and removing toxicity. Since it is important for conditioning of dampness to promote urination, the prescription includes lophatherum gracile which brings the dampness away from the urine, and semen raphani which regulates lower-qi.

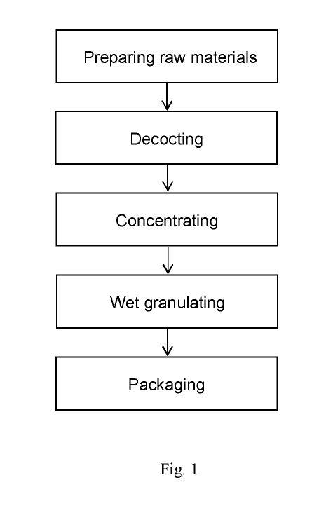

As shown in FIG. 1, a method for processing a solid beverage for conditioning dampness-heat constitution comprises the steps of:

(1) Preparation of raw materials: subjecting agastache rugosa, semen coicis, dandelion, honeysuckle, houttuynia, rhizoma phragmitis, lophatherum gracile and fried semen raphani to decontamination, purification, cutting and pulverization followed by mixing them for subsequent use; the ratio between the raw materials employs the ratio provided by the present invention.

(2) decoction: decocting twice the mixture obtained in step (1) with addition of water to obtain a Chinese medicine liquid;

(3) concentration: feeding the Chinese medicine liquid obtained in step (2) into a thickener via a pipeline, and concentrating it into a thick paste;

(4) wet granulation: mixing dextrin, maltodextrin, soluble starch and aspartame under stirring to obtain a mixed excipient, and adding the thick paste obtained in step (3) to the mixed excipient, followed by stirring granulation.

(5) packaging: subject products after wet granulation to a packaging step to obtain the finished product.

The purpose of the step (1) is to defat the seed medicinal material by pulverizing it and passing through a 2-mesh sieve. Since the rhizome medicinal material is rich in cellulose and starch, cutting and pulverizing can effectively retain the target components and prevent the polysaccharide from swelling. Purification can remove impurities and soil to effectively reduce residual amount of pollutants such as heavy metals and pesticides.

The twice decocting processes in the step (2) above are operated as follows: for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

The temperature for the concentration in the step (3) above is 70-80° C., and the relative density of the resulted thick paste is 1.2-1.5 at a temperature of 50° C. Low temperature evaporation can effectively reduce the decomposition of heat-sensitive ingredients, such as organic acids such as citric acid, malic acid, and oxalic acid. The concentration process is of high efficiency and does not emit solvent vapor, which facilitates evaporation, maintains a hermetically sealed condition and produces no pollution to the environment.

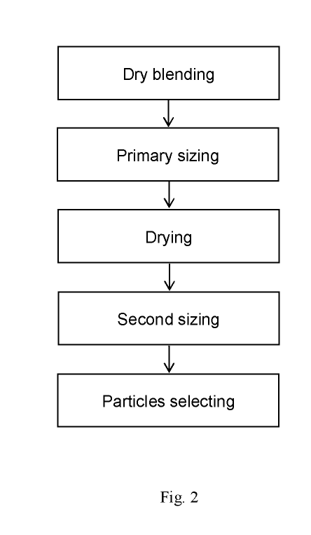

As shown in FIG. 2, the wet granulation in the step (4) above comprises the steps of:

(4.1) dry blending: feeding dextrin, maltodextrin, soluble starch, and aspartame into a high efficiency mixing granulator followed by mixing under stirring for 15 minutes, to obtain the mixed excipient; the ratio between the raw materials employs the ratio provided by the present invention.

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time; the granulation under stirring is preferred to prevent the separation of the ingredients. Since the components in the mixed extract, due to their differences of the particle size and density, are prone to segregation, the granulation can not only effectively improve this problem, but also significantly improve the solubility.

(4.3) drying: putting the sized particles obtained in step (4.2) into a boiling dryer for drying; boiling drying can effectively control the particle size distribution, and the product moisture.

(4.4) secondary sizing: performing the second time of sizing by an oscillating machine; the secondary sizing can control the particle size distribution, bulk density and compactness;

In the above steps, the sieve used for the primary sizing is a 12-mesh sieve, and the sieve used for the secondary sizing is a 10-mesh sieve.

The material temperature during the drying process in step (4.3) above is controlled at 70-80° C. and the final moisture content of the material is controlled below 5%. In this step, it is possible to turn over the pot according to the drying conditions of the material to ensure the final moisture content of the material meets the requirements.

On the basis of the above embodiment, after the secondary sizing, it further comprises a particle-selecting step wherein particles of 10 to 60 mesh are selected. The particle-selecting step can improve the appearance and uniformity of the product particles. In practice, after the completion of the particle-selecting a record can be filled out and labeling can be made to note product name, product batch number, specifications, net weight, date of production, job title, responsible person, followed by filling out the transfer order and transferring the product to the middle station.

### Example 1

A solid beverage for conditioning dampness-heat constitution comprised in parts by weight the following ingredients of raw materials: 40 parts of agastache rugosa, 22 parts of dandelion, 15 parts of honeysuckle, 16 parts of rhizoma phragmitis, 17 parts of lophatherum gracile, 18 parts of fried semen raphani, 20 parts of semen coicis, 21 parts of houttuynia, 23 parts of dextrin, 15 parts of maltodextrin, 30 parts of soluble starch, and 0.1 parts of aspartame.

The preparation method was as follows:

(1) Preparation of raw materials: subjecting agastache rugosa, semen coicis, dandelion, honeysuckle, houttuynia, rhizoma phragmitis, lophatherum gracile and fried semen raphani in above ratio to decontamination, purification, cutting and pulverization followed by mixing them for subsequent use;

(2) decoction: decocting twice the mixture obtained in step (1) with addition of water to obtain a Chinese medicine liquid, and the twice decoction processes were as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

(3) Concentration: feeding the Chinese medicine liquid obtained in step (2) into a thickener and concentrating it into a thick paste, wherein the temperature for the concentration is 70° C., and the relative density of the resulted thick paste is 1.2 at a temperature of 50° C.

(4) wet granulation

(4.1) dry blending: feeding dextrin, maltodextrin, soluble starch, and aspartame in above ratio into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time using a 12-mesh sieve;

(4.3) drying: putting the sized particles obtained in step (4.2) into a boiling dryer for drying, wherein the material temperature is controlled at 70° C. and the final moisture content of the material is controlled below 5%;

(4.4) secondary sizing: performing the second time of sizing by an oscillating machine using a 10-mesh sieve;

(4.5) particle-selection: selecting particle with 10-60 mesh.

(5) Packaging: filling the particles that have been inspected and passed after mixing into bags according to the standard operating procedure of automatic packaging machine, and checking the bags for appearance and quantity at any time. If there is any abnormal condition, the procedure is adjusted in time. The filled particles was kept in a clean and airtight container on which name of product, batch number, quantity, date are noted for use. Reference loading capacity is 8 g/bag, and loading limit is 8 g/bag±5%.

### Example 2

A solid beverage for conditioning dampness-heat constitution comprised in parts by weight the following ingredients of raw materials: 40 parts of agastache rugosa, 41 parts of dandelion, 45 parts of honeysuckle, 42 parts of rhizoma phragmitis, 45 parts of lophatherum gracile, 38 parts of fried semen raphani, 43 parts of semen coicis, 45 parts of houttuynia, 43 parts of dextrin, 38 parts of maltodextrin, 60 parts of soluble starch, and 0.3 parts of aspartame.

The preparation method was as follows:

(1) Preparation of raw materials: subjecting agastache rugosa, semen coicis, dandelion, honeysuckle, houttuynia, rhizoma phragmitis, lophatherum gracile and fried semen raphani in above ratio to decontamination, purification, cutting and pulverization followed by mixing them for subsequent use;

(2) decoction: decocting twice the mixture obtained in step (1) with addition of water to obtain a Chinese medicine liquid, and the twice decoction processes were as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

(3) Concentration: feeding the Chinese medicine liquid obtained in step (2) into a thickener and concentrating it into a thick paste, wherein the temperature for the concentration is 80° C., and the relative density of the resulted thick paste is 1.5 at a temperature of 50° C.

(4) wet granulation

(4.1) dry blending: feeding dextrin, maltodextrin, soluble starch, and aspartame in above ratio into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time using a 12-mesh sieve;

(4.3) drying: putting the sized particles obtained in step (4.2) into a boiling dryer for drying, wherein the material temperature is controlled at 80° C. and the final moisture content of the material is controlled below 3%;

(4.4) secondary sizing: performing the second time of sizing by an oscillating machine using a 10-mesh sieve;

(4.5) particle-selection: selecting particle with 10-60 mesh.

(5) Packaging: filling the particles that have been inspected and passed after mixing into bags according to the standard operating procedure of automatic packaging machine, and checking the bags for appearance and quantity at any time. If there is any abnormal condition, the procedure is adjusted in time. The filled particles was kept in a clean and airtight container on which name of product, batch number, quantity, date are noted for use. Reference loading capacity is 8 g/bag, and loading limit is 8 g/bag±5%.

### Example 3

A solid beverage for conditioning dampness-heat constitution comprised in parts by weight the following ingredients of raw materials: 23 parts of agastache rugosa, 26 parts of dandelion, 22 parts of honeysuckle, 21 parts of rhizoma phragmitis, 20 parts of lophatherum gracile, 22 parts of fried semen raphani, 25 parts of semen coicis, 24 parts of houttuynia, 27 parts of dextrin, 18 parts of maltodextrin, 35 parts of soluble starch, and 0.15 parts of aspartame.

The preparation method was as follows:

(1) Preparation of raw materials: subjecting agastache rugosa, semen coicis, dandelion, honeysuckle, houttuynia, rhizoma phragmitis, lophatherum gracile and fried semen raphani in above ratio to decontamination, purification, cutting and pulverization followed by mixing them for subsequent use;

(2) decoction: decocting twice the mixture obtained in step (1) with addition of water to obtain a Chinese medicine liquid, and the twice decoction processes were as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

(3) Concentration: feeding the Chinese medicine liquid obtained in step (2) into a thickener and concentrating it into a thick paste, wherein the temperature for the concentration is 75° C., and the relative density of the resulted thick paste is 1.45 at a temperature of 50° C.

(4) wet granulation

(4.1) dry blending: feeding dextrin, maltodextrin, soluble starch, and aspartame in above ratio into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time using a 12-mesh sieve;

(4.3) drying: putting the sized particles obtained in step (4.2) into a boiling dryer for drying, wherein the material temperature is controlled at 78° C. and the final moisture content of the material is controlled below 3.4%;

(4.4) secondary sizing: performing the second time of sizing by an oscillating machine using a 10-mesh sieve;

(4.5) particle-selection: selecting particle with 10-60 mesh.

(5) Packaging: filling the particles that have been inspected and passed after mixing into bags according to the standard operating procedure of automatic packaging machine, and checking the bags for appearance and quantity at any time. If there is any abnormal condition, the procedure is adjusted in time. The filled particles was kept in a clean and airtight container on which name of product, batch number, quantity, date are noted for use. Reference loading capacity is 8 g/bag, and loading limit is 8 g/bag±5%.

### Example 4

A solid beverage for conditioning dampness-heat constitution comprised in parts by weight the following ingredients of raw materials: 37 parts of agastache rugosa, 35 parts of dandelion, 38 parts of honeysuckle, 37 parts of rhizoma phragmitis, 39 parts of lophatherum gracile, 33 parts of fried semen raphani, 35 parts of semen coicis, 39 parts of houttuynia, 37 parts of dextrin, 33 parts of maltodextrin, 55 parts of soluble starch, and 0.25 parts of aspartame.

The preparation method was as follows:

(1) Preparation of raw materials: subjecting agastache rugosa, semen coicis, dandelion, honeysuckle, houttuynia, rhizoma phragmitis, lophatherum gracile and fried semen raphani in above ratio to decontamination, purification, cutting and pulverization followed by mixing them for subsequent use;

(2) decoction: decocting twice the mixture obtained in step (1) with addition of water to obtain a Chinese medicine liquid, and the twice decoction processes were as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

(3) Concentration: feeding the Chinese medicine liquid obtained in step (2) into a thickener and concentrating it into a thick paste, wherein the temperature for the concentration is 73° C., and the relative density of the resulted thick paste is 1.33 at a temperature of 50° C.

(4) wet granulation

(4.1) dry blending: feeding dextrin, maltodextrin, soluble starch, and aspartame in above ratio into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time using a 12-mesh sieve;

(4.3) drying: putting the sized particles obtained in step (4.2) into a boiling dryer for drying, wherein the material temperature is controlled at 72° C. and the final moisture content of the material is controlled below 4.5%;

(4.4) secondary sizing: performing the second time of sizing by an oscillating machine using a 10-mesh sieve;

(4.5) particle-selection: selecting particle with 10-60 mesh.

(5) Packaging: filling the particles that have been inspected and passed after mixing into bags according to the standard operating procedure of automatic packaging machine, and checking the bags for appearance and quantity at any time. If there is any abnormal condition, the procedure is adjusted in time. The filled particles was kept in a clean and airtight container on which name of product, batch number, quantity, date are noted for use. Reference loading capacity is 8 g/bag, and loading limit is 8 g/bag±5%.

### Example 5

A solid beverage for conditioning dampness-heat constitution comprised in parts by weight the following ingredients of raw materials: 30 parts of agastache rugosa, 30 parts of dandelion, 30 parts of honeysuckle, 30 parts of rhizoma phragmitis, 30 parts of lophatherum gracile, 30 parts of fried semen raphani, 30 parts of semen coicis, 30 parts of houttuynia, 30 parts of dextrin, 25 parts of maltodextrin, 45 parts of soluble starch, and 0.2 parts of aspartame.

The preparation method was as follows:

(1) Preparation of raw materials: subjecting agastache rugosa, semen coicis, dandelion, honeysuckle, houttuynia, rhizoma phragmitis, lophatherum gracile and fried semen raphani in above ratio to decontamination, purification, cutting and pulverization followed by mixing them for subsequent use;

(2) decoction: decocting twice the mixture obtained in step (1) with addition of water to obtain a Chinese medicine liquid, and the twice decoction processes were as follows:

for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

(3) Concentration: feeding the Chinese medicine liquid obtained in step (2) into a thickener and concentrating it into a thick paste, wherein the temperature for the concentration is 77° C., and the relative density of the resulted thick paste is 1.4 at a temperature of 50° C.

(4) wet granulation

(4.1) dry blending: feeding dextrin, maltodextrin, soluble starch, and aspartame in above ratio into a high efficiency mixing granulator followed by mixing under stirring for 15 minutes, to obtain the mixed excipient;

(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time using a 12-mesh sieve;

(4.3) drying: putting the sized particles obtained in step (4.2) into a boiling dryer for drying, wherein the material temperature is controlled at 76° C. and the final moisture content of the material is controlled below 3.8%;

(4.4) secondary sizing: performing the second time of sizing by an oscillating machine using a 10-mesh sieve;

(4.5) particle-selection: selecting particle with 10-60 mesh.

(5) Packaging: filling the particles that have been inspected and passed after mixing into bags according to the standard operating procedure of automatic packaging machine, and checking the bags for appearance and quantity at any time. If there is any abnormal condition, the procedure is adjusted in time. The filled particles was kept in a clean and airtight container on which name of product, batch number, quantity, date are noted for use. Reference loading capacity is 8 g/bag, and loading limit is 8 g/bag±5%.

### Experimental Example 1: Evaluation of Effectiveness of the Solid Beverage for Conditioning Dampness-Heat Prepared in Example 5

Basic information about cases: 300 clinical cases with dampness-heat constitution, including 150 males and 150 females.

Usage and dosage: Each 8 grams, twice daily. Administration after dissolved by 200 ml boiled water.

Evaluation Criteria of Effectiveness:

Cured: the clinical symptoms disappear completely, and the patient has returned to normal life.

Effective: the clinical symptoms disappeared partly, the signs of the patient are gradually improved.

Ineffective: there is no significant improvement in symptoms and signs of patient.

Results Statistics: 219 cases were cured, 53 cases were effective, 28 cases were ineffective. The total effective number is 272 cases, and the total efficiency of 90.67%.

### Experimental Example 2: Sensory Evaluation

The solid beverage prepared in Examples 1 to 5 was dissolved with boiled water and then taken as test groups, and the mixed medicine liquid after the twice decoction obtained in step (2) in the processing process of Example 5 as a control group. 3 repeats were set up for samples of the test groups and the control group. The sensory evaluation was performed by 20 professional sensory evaluators. The sensory evaluating and scoring standards are shown in Table 1, and the sensory evaluation results are summarized in Table 2.

TABLE 1
Sensory Evaluating and Scoring Standards

| Item | Sensory Evaluation | Score |
|---|---|---|
| Color | dark | 1 |
| | moderate | 5 |
| | light | 1 |
| Odor | strong Chinese medicine | 1 |
| | smell | |
| | slight Chinese medicine | 3 |
| | smell | |
| | medicine fragrance | 5 |
| | relatively light | 3 |
| | light | 1 |
| taste | bitter | 1 |
| | relatively bitter | 3 |
| | fragrant and sweet | 5 |
| | relatively sweet | 3 |
| | too sweet | 1 |
| Smoothness | Fine and smooth | 5 |
| | particle sensation | 3 |
| | scratching throat sensation | 1 |
| | hard to swallow | 0 |
| Overall Evaluation | bad | — |
| | ordinary | — |
| | good | — |

TABLE 2
Sensory Evaluation Results

| | | Control | Test Groups | | | | | |
|---|---|---|---|---|---|---|---|---|
| Item | | Group | Example 1 | Example 2 | Example 3 | Example 4 | Example 5 | mean |
| Sensory | Color | 54 | 94 | 95 | 91 | 94 | 97 | 94.2 |
| Evaluation | Odor | 38 | 96 | 90 | 92 | 96 | 95 | 93.8 |
| (score) | Taste | 29 | 87 | 93 | 90 | 90 | 88 | 89.6 |
| | Smoothness | 77 | 93 | 95 | 97 | 93 | 94 | 94.4 |
| | Mean | 49.5 | 92.5 | 93.25 | 92.5 | 93.25 | 93.5 | 93 |
| Overall | Good | 9 | 16 | 18 | 20 | 19 | 18 | 18.2 |
| Evaluation | Ordinary | 3 | 4 | 2 | 0 | 0 | 2 | 1.6 |
| (person-time) | Bad | 8 | 0 | 0 | 0 | 1 | 0 | 0.2 |

It can be seen from the above test results that the mean scores of the color, odor, taste, and smoothness of the solid beverage obtained in Examples 1 to 5 evaluated by the 20 professional sensory evaluators are higher than those of the control group. The results show that the solid beverage provided in the present invention is greatly improved in odor and taste over the medicine liquid obtained after decocting a Chinese medicine decoction piece. Moreover, since the sweet taste is added, and the taste and the smoothness are both substantially improved, the product is quite suitable for daily drinking.

### Experimental Example 3: Animal Experiment

Wistar rats were divided into 7 groups, 10 rats in each group, half male and half female, including control group, model group, and 5 experimental groups of Examples 1 to 5 of the present invention. In addition to the control group for normal diet in the normal environment, the remaining groups were subjected to modeling of damp-heat syndrome in accordance with “Chinese medicine experimental methodology” 1st Ed., the People's Health Press, pressed in May 2008. The specific modeling methods is high-sucrose and high-fat diet, climate (temperature of 35° C. and air relative humidity of 95%), Salmonella typhimurium (106/ml). The rats were fed with high-sucrose and high-fat diet for 10 days, and subsequently put into a modeling box at temperature of 35° C. with a relative humidity of 95%. After 96 h, Salmonella typhimurium was applied in an amount of 2 ml/200 g (body weight) by gavage, and at the time of 120 h, infection was enhanced once [1 ml/200 g (body weight)] for 120 h. Thereafter, the rats were removed and placed in the natural environment. This is the model group of rats. Rats in normal group were fed with normal diet under normal environment.

The experimental group according to the invention was given the solid beverage particles prepared in Examples 1 to 5 of the present invention. The solid beverage particles were administrated by gavage for one week at a dosage for rat of 0.3 g/rat/day, which was obtained after conversion from a dosage for human being of 18 g/60 kg body weight. After one week of administration, the artery blood was sampled and the rats were sacrificed. The solid beverage particles was tested for the effect on body weight and blood viscosity of the dampness-heat model rats. The solid beverage particles was tested for the effect on the SOD (superoxide dismutase) and MDA (malondialdehyde) expression in serum and skin of the dampness-heat model rats. The experimental results are shown in Table 3. The experimental results are shown in Table 4.

TABLE 3
Effect of the solid beverage particles of the invention on body weight and
blood viscosity of the dampness-heat model rats

| | | | Blood midst shear |
|---|---|---|---|
| Group | Number | Weight | viscosity (mpa · s)(115 s⁻¹) |
| Control | 10 | 305 ± 9.8** | 3.53 ± 0.19** |
| group | | | |
| Model group | 10 | 226 ± 11.2^{##} | 6.97 ± 0.24^{##} |
| Example 1 | 10 | 283 ± 12.1* | 4.58 ± 0.54** |
| Example 2 | 10 | 291 ± 12.5* | 4.71 ± 0.39** |
| Example 3 | 10 | 269 ± 11.5** | 4.08 ± 0.21** |
| Example 4 | 10 | 273 ± 10.8* | 3.99 ± 0.18* |
| Example 5 | 10 | 288 ± 9.1** | 4.15 ± 0.22** |

TABLE 4
Effect of the solid beverage particles of the invention on the SOD and
MDA expression in serum and skin of the dampness-heat model rats

| | | Blood SOD | Skin SOD | Blood MDA | Skin MDA |
|---|---|---|---|---|---|
| Group | Number | (nmol/ml) | (nmol/ml) | (nmol/ml) | (nmol/ml) |
| Control | 10 | 7.18 ± 1.04** | 1.31 ± 0.023** | 5.38 ± 0.49** | 0.73 ± 0.07** |
| group | | | | | |
| Model | 10 | 3.02 ± 0.94^{##} | 0.42 ± 0.009^{##} | 8.02 ± 0.47^{##} | 1.03 ± 0.05^{##} |
| group | | | | | |
| Example 1 | 10 | 6.54 ± 1.25** | 0.76 ± 0.006** | 7.06 ± 0.62** | 0.91 ± 0.03** |
| Example 2 | 10 | 6.08 ± 1.24* | 0.71 ± 0.008** | 6.86 ± 0.37* | 0.88 ± 0.03** |
| Example 3 | 10 | 5.64 ± 0.93** | 0.86 ± 0.004* | 6.22 ± 0.54* | 0.82 ± 0.05** |
| Example 4 | 10 | 5.38 ± 0.87** | 0.68 ± 0.006** | 6.01 ± 0.47** | 0.86 ± 0.08** |
| Example 5 | 10 | 5.21 ± 0.96** | 0.84 ± 0.008** | 5.86 ± 0.51** | 0.80 ± 0.06* |

(note: # compared with normal group ##p<0.01, #p<0.05; * compared with model group *p<0.01, **p<0.05)

As can be seen from Table 3 that the solid beverage particles in Examples 1 to 5 of the invention can significantly increase the body weight of the model rats and lower the whole blood viscosity, and have significant differences compared with the model group (p<0.01, p<0.05).

It can be seen from Table 4 that all of the prescriptions of Examples 1 to 5 of the invention can significantly increase the concentration of SOD in blood and skin so as to enhance the antioxidant capacity of the body. Meanwhile, the MDA in blood and skin of the model rats at each dosage is substantially decreased, indicating a reduction of the body's degree of oxidation.

The foregoing descriptions are merely preferred embodiments of the present invention and are not intended to limit the present invention. For those skilled in the art, various modifications and changes can be made to the present invention. Any modification, equivalent replacement, improvement and the like made within the spirit and principle of the present invention should be encompassed in the protective scope of the present invention.

What is claimed is:

1. A solid beverage for conditioning dampness-heat constitution comprising in parts by weight the following ingredients of raw materials: from 18 to 40 parts of agastache rugosa, from 22 to 41 parts of dandelion, from 15 to 45 parts of honeysuckle, from 16 to 42 parts of rhizoma phragmitis, from 17 to 45 parts of lophatherum gracile, from 18 to 38 parts of fried semen raphani, from 20 to 43 parts of semen coicis, from 21 to 45 parts of houttuynia, from 23 to 43 parts of dextrin, from 15 to 38 parts of maltodextrin, from 30 to 60 parts of soluble starch, and from 0.1 to 0.3 parts of aspartame.

2. The solid beverage for conditioning dampness-heat constitution of claim 1, wherein it comprises in parts by weight the following ingredients of raw materials: from 23 to 37 parts of agastache rugosa, from 26 to 35 parts of dandelion, from 22 to 38 parts of honeysuckle, from 21 to 37 parts of rhizoma phragmitis, from 20 to 39 parts of lophatherum gracile, from 22 to 33 parts of fried semen raphani, from 25 to 35 parts of semen coicis, from 24 to 39 parts of houttuynia, from 27 to 37 parts of dextrin, from 18 to 33 parts of maltodextrin, from 35 to 55 parts of soluble starch, and from 0.15 to 0.25 parts of aspartame.

3. The solid beverage for conditioning dampness-heat constitution of claim 1, wherein it comprises in parts by weight the following ingredients of raw materials: 30 parts of agastache rugosa, 30 parts of dandelion, 30 parts of honeysuckle, 30 parts of rhizoma phragmitis, 30 parts of lophatherum gracile, 30 parts of fried semen raphani, 30 parts of semen coicis, 30 parts of houttuynia, 30 parts of dextrin, 25 parts of maltodextrin, 45 parts of soluble starch, and 0.2 parts of aspartame.

4. A method for processing a solid beverage for conditioning dampness-heat constitution comprising the steps of:
(1) Preparation of raw materials: subjecting agastache rugosa, semen coicis, dandelion, honeysuckle, houttuynia, rhizoma phragmitis, lophatherum gracile and fried semen raphani to decontamination, purification, cutting and pulverization followed by mixing them for subsequent use;
(2) decoction: decocting twice the mixture obtained in step (1) with addition of water to obtain a Chinese medicine liquid;
(3) concentration: feeding the Chinese medicine liquid obtained in step (2) into a thickener via a pipeline, and concentrating it into a thick paste;
(4) wet granulation: mixing dextrin, maltodextrin, soluble starch and aspartame under stirring to obtain a mixed excipient, and adding the thick paste obtained in step (3) to the mixed excipient, followed by stirring granulation.

5. The method for processing a solid beverage for conditioning dampness-heat constitution of claim 4, wherein the twice decocting processes in the step (2) are operated as follows:
for the first decoction, adding water in an amount of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;
for the second decoction, adding water in an amount of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it homogeneously with the medicine liquid obtained from the first time of decoction and extraction.

6. The method for processing a solid beverage for conditioning dampness-heat constitution of claim 4, wherein the temperature for the concentration in the step (3) is 70-80° C., and the relative density of the resulted thick paste is 1.2-1.5 at a temperature of 50° C.

7. The method for processing a solid beverage for conditioning dampness-heat constitution of claim 4, wherein the wet granulation in the step (4) comprises the steps of:
(4.1) dry blending: feeding dextrin, maltodextrin, soluble starch, and aspartame into a high efficiency mixing granulator followed by mixing under stirring for 15 minutes, to obtain the mixed excipient;
(4.2) primary sizing: adding the thick paste extracted in step (3) gradually to the mixed excipient, mixing under stirring the thick paste at cutting speed I and stirring speed I to granulate them to obtain a soft material, and sizing the soft material for the first time;
(4.3) drying: putting the sized particles obtained in step (4.2) into a boiling dryer for drying;
(4.4) secondary sizing: performing the second time of sizing by an oscillating machine.

8. The method for processing a solid beverage for conditioning dampness-heat constitution of claim 7, wherein the sieve used for the primary sizing is a 12-mesh sieve, and the sieve used for the secondary sizing is a 10-mesh sieve.

9. The method for processing a solid beverage for conditioning dampness-heat constitution of claim 7, wherein the material temperature during the drying process in step (4.3) is controlled at 70-80° C. and the final moisture content of the material is controlled below 5%.

10. The method for processing a solid beverage for conditioning dampness-heat constitution of claim 7, wherein, after the secondary sizing, it further comprises a particle-selecting step wherein particles of 10 to 60 mesh are selected.
